(19) United States
(12) Patent Application Publication
(10) Pub. No.: US 2005/0037323 A1
(43) Pub. Date: Feb. 17, 2005

(54) Method and charm holder for behavioral control

(76) Inventor: Kathryn Basson, Newburyport, MA (US)

Correspondence Address: BROMBERG & SUNSTEIN LLP, 125 SUMMER STREET, BOSTON, MA, 02110-1618, US

(21) Appl. No.: 10/642,112

(22) Filed: Aug. 15, 2003

(51) Int. Cl. G09B 19/00

(52) U.S. Cl. 434/236

(57) ABSTRACT

A method of encouraging a person to modify a behavior. The method includes providing a charm holder capable of being worn by the person and adjusting the number of charms attached to the charm holder as a function of the behavior of the person. The charm holder may be a necklace that includes a plurality of chains that are combined together via magnetic clasps. Each of the chains may have a length of no greater than seven inches.

### TECHNICAL FIELD

The present invention relates generally to behavior control, and more specifically to a portable method and apparatus for modifying behavior of a person.

### BACKGROUND ART

Various methods for behavior modification are known in the art. For example, a teacher or parent may provide either a positive or negative consequence upon observing a targeted behavior by a child. Positive consequences may include providing various reinforcers (rewards), such as a prize, candy, or adding a certain privilege. Alternatively, negative consequences may include a form of punishment, such as physically punishing a child, or removing certain privileges. Consequences may be reinforced with the child by making a contract that describes in writing the target behavior and the associated consequence. A behavioral chart can also be provided so that a child can periodically review the chart in a group or individual setting. Such a chart can be used not only to determine progress, but also to serve as a reminder for the child that a targeted behavior has an associated consequence.

However, unless constantly reminded, a young child will often forget or fail to focus on the targeted behavior and/or consequence. Periodic review of a child's behavioral chart, which may occur at the end of the day, is often not sufficient to keep the child focused on the targeted behavior. More frequent access to the behavioral chart is problematic, as the child is often participating in activities that are physically removed from the chart. Since the child does not remain focused on the targeted behavior, a longer period of time is typically needed to complete the behavior modification.

### SUMMARY OF THE INVENTION

A first embodiment of the invention provides a method for encouraging a person to modify a behavior. The method includes providing a charm holder capable of being worn by the person. The number of charms attached to the charm holder is adjusted as a function of the behavior of the person.

In related embodiments of the invention, adjusting the amount of charms attached to the charm holder may include adding or removing a charm from the charm holder based, for example, on a positive or a negative behavior, respectively. A predetermined number of charms may be attached to the charm holder when the charm holder is provided. The charm holder may be a necklace, a bracelet, a carabiner, a pin, a belt or a key ring. The method may further include attaching the charm holder to the person. The behavior to be modified may be unrelated to the act of wearing the charm holder.

In a further related embodiment a predetermined number of charms are attached to the charm holder at the start of a specified duration of time. Based at least on the number of charms attached to the charm holder after the predetermined duration of time has elapsed, a determination is made as to whether proper behavior was achieved during the specified duration of time. A chart may be provided that includes a plurality of spaces, each space for marking that proper behavior has been achieved for the specified duration of time. One of the spaces on the chart is marked when proper behavior for the specified duration of time has been achieved. The steps of attaching, determining, and marking may be repeated until a predetermined number of spaces on the chart has been marked.

In related embodiments of the invention, marking one of the spaces on the chart may include attaching a sticker to one of the spaces on the chart. A reward may be provided to the person when proper behavior for the specified duration of time has been achieved. The reward may be a coin that can be used to purchase a prize.

In a further related embodiment of the invention, in providing the charm holder, a plurality of chains may be provided. The chains are combined, via, without limitation, magnetic clasps or Velcro, to form the charm holder. Each chain may be no greater than seven inches long.

In another embodiment of the invention, a kit for encouraging a person to modify a behavior is provided. The kit includes a charm holder and a plurality of charms. Also included in the kit are instructions that include directions for adjusting the number of charms attached to the charm holder based on, at least in part, a behavior of the person.

In a related embodiment of the invention, the instructions further include directions for attaching a predetermined number of charms to the charm holder at the start of a specified duration of time; and determining whether proper behavior during the specified duration of time has been achieved based at least on the number of charms attached to the charm holder after the predetermined duration of time has elapsed. The kit may further include a chart that includes a plurality of spaces. The instructions may include directions for marking one of the spaces on the chart when proper behavior for the specified duration of time has been achieved. The instructions may further include directions for repeating attaching, determining, and marking, until a predetermined number of spaces on the chart have been marked.

In related embodiments of the invention, the kit may further include stickers for marking one of the spaces on the chart. The kit may include a plurality of rewards, with the instructions including directions for providing at least one of the rewards to the person when proper behavior for the specified duration of time has been achieved. The plurality of rewards may include at least one coin and at least one prize, the coin for purchasing one of the prizes. The charm holder may be a necklace, a bracelet, a carabiner, a pin, a belt and a key ring. The kit may include a plurality of chains that can be combined by, for example, magnetic clasps to form the charm holder. Each chain may have a length no greater than seven inches. Three chains may be combined, via magnetic clasps, to form the charm holder, each chain having a length of substantially six inches.

In another embodiment of the invention, a charm holder includes a plurality of chains. Each chain has a first magnetic clasp at a first end and a second magnetic clasp at a second end. The chains are combined, via the magnetic clasps, to form the charm holder. Instead of magnetic clasps, other clasps may be utilized, such as, without limitation, velcro clasps. The magnetic clasps may separate upon applying a separation force greater than 7 lbs/square inch.

In related embodiments of the invention, each chain may have a length of substantially seven inches or less. For example, each chain may have a length of substantially six inches. One or more charms may be attached to the charm holder. The charm holder may be chosen from the group consisting of a necklace, a bracelet, a carabiner, a pin, a belt and a key ring. The charm holder may be a necklace having three chains, each chain substantially six inches long. Each chain may be made of non-magnetic metal, string, and/or plastic.

In still another embodiment of the invention, a method for making a charm holder is presented. The method includes providing a plurality of chains, each chain including a first magnetic clasp at a first end and a second magnetic clasp at a second end. The plurality of chains are combined, via the magnetic clasps, to form the charm holder. Instead of magnetic clasps, other clasps may be utilized, such as a Velcro clasp.

In yet another embodiment of the invention, a charm holder includes a plurality of chains, each chain having a length no greater than seven inches. For example, each chain may have a length of substantially six inches. The charm holder includes means for attaching the plurality of chains together to form the charm holder, the means for attaching separating upon applying a separation force greater than 7 lbs/square inch. The means for attaching may include, without limitation, one of a magnetic clasp and a velcro clasp.

### BRIEF DESCRIPTION OF THE DRAWINGS

The foregoing features of the invention will be more readily understood by reference to the following detailed description, taken with reference to the accompanying drawings, in which:

FIG. 1 shows a flowchart of a method for modifying a behavior of a person, in accordance with one embodiment of the invention;

FIG. 2 shows a perspective view of exemplary charms attached to a charm holder, in accordance with one embodiment of the invention;

FIG. 3 shows a contract, worksheet and chart that can be used in conjunction with a charm holder, in accordance with one embodiment of the invention; and

FIG. 4 shows a perspective view of a charm holder, in accordance with one embodiment of the invention.

### DETAILED DESCRIPTION OF SPECIFIC EMBODIMENTS

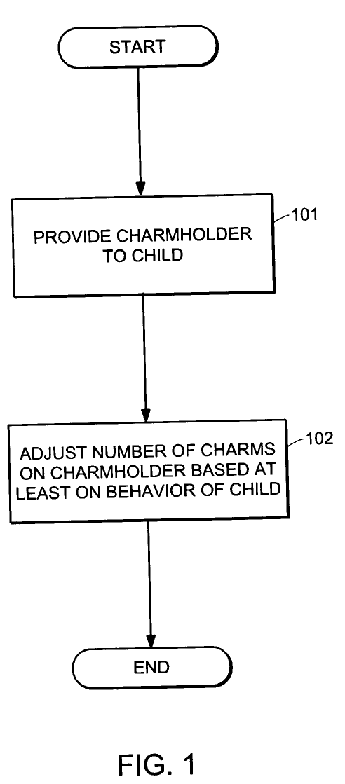

FIG. 1 is a flowchart illustrating a portable method of encouraging a person, such as a child and/or a student, to modify a behavior, in accordance with one embodiment of the invention. For exemplary purposes, the word “child” shall be used in the specification to refer to the person whose behavior is being targeted, while the word “parent” shall be used in the specification to refer to the person attempting to modify the behavior of the child. However, it is to be understood that embodiments of the present invention may be used in many environments, such as school, work, or home environments, and that the person whose behavior is targeted and the person(s) attempting to modify the behavior is not limited to a child and a parent, respectively.

The method begins at step 101, in which a charm holder is provided that is to be worn by a child. The charm holder, to which at least one charm can be added or removed, may be one of a wide variety of items that can be worn by the child. For example, the charm holder may be a necklace, a bracelet, a key ring, a pin, a belt, or a carabiner. The charms can easily attach to, or be removed from, the charm holder using, without limitation: a split ring; a jump ring; various types of clasps, such as a lobster claw or C-clasp; and/or the charm may be attached to the charm holder by passing the charm holder through a hole in the charm. As used in this description and the accompanying claims, the term “worn” shall encompass both wearing and carrying, and the term “charm” shall mean an ornament or token that can be attached to the charm holder, unless the context otherwise requires.

The charms may be of random design. Alternatively, the charms may be associated with a particular theme that is of interest to the child. For example, charm designs may be related to, without limitation, sports, games, crafts, stories, nature, animals, or celestial bodies. The charms may be colored, and be of various sizes and shapes. In various embodiments, the charms can include letters or words which may further form a name or sentence, respectively, when attached in a particular sequence on the charm holder. The charm may be made of various materials, including, without limitation, metal or plastic.

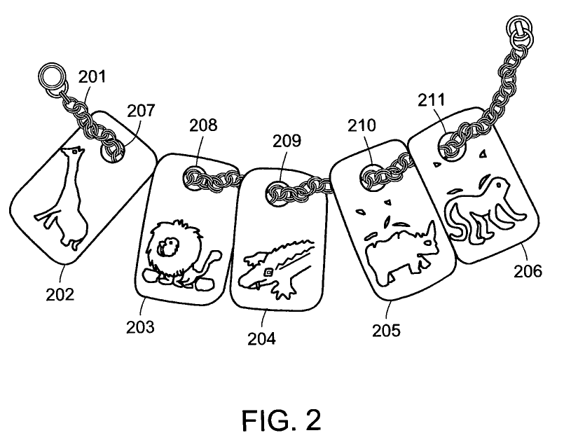

FIG. 2 shows exemplary embodiments of charms 202-206 attached to a charm holder 201. Each charm 202-206 includes a graphic illustration of an animal. The graphic illustration, which can be printed on paper or another suitable medium, may have a plastic coating which can be formed, for example, by a lamination process. The charm 202-205 may have multiple surfaces, with the same or a different graphical illustration observable on each of the multiple surfaces. The laminated paper may include at least one hole 207-211 through which the charm holder 201 can be inserted.

Referring back to FIG. 1, the number of charms attached to the charm holder is adjusted based at least on the behavior of the child (step 102). Charms may be either removed or added to the charm holder. The number of charms on the charm holder can be adjusted immediately upon observation of the targeted behavior, or when otherwise convenient.

In various embodiments of the invention, adding or removing a charm from the charm holder acts as a positive and negative consequence, respectively. For example, a positively viewed charm may be added to the charm holder based on good behavior, thus providing motivation to repeat the good behavior. Bad behavior, on the other hand, may result in a charm being removed from the charm holder, serving to discourage future bad behavior. Note that in alternative embodiments of the invention, adding a charm can be a negative, instead of a positive consequence, and removing a charm a positive consequence.

Since the child carries and/or wears the charm holder, the above-described method for behavioral control is portable and effectively serves to remind the child of the targeted behavior throughout the day. This is particularly important in younger children, who tend to lose focus on the targeted behavior when not reminded frequently. Additionally, the charm holder is often visible to other people, providing further motivation to the child wearing the charm holder to accumulate charms, consequently indicating to various people that good behavior has been achieved.

Known behavioral control methods may be used in combination with embodiments of the present invention to further emphasize the targeted behavior. For example, embodiments of the present invention may be used in combination with a contract between the child and parent. The contract may be incorporated into a chart, typically affixed to a wall, to track and/or summarize the targeted behavior for a given period of time. Prizes also may be provided after certain goals have been reached.

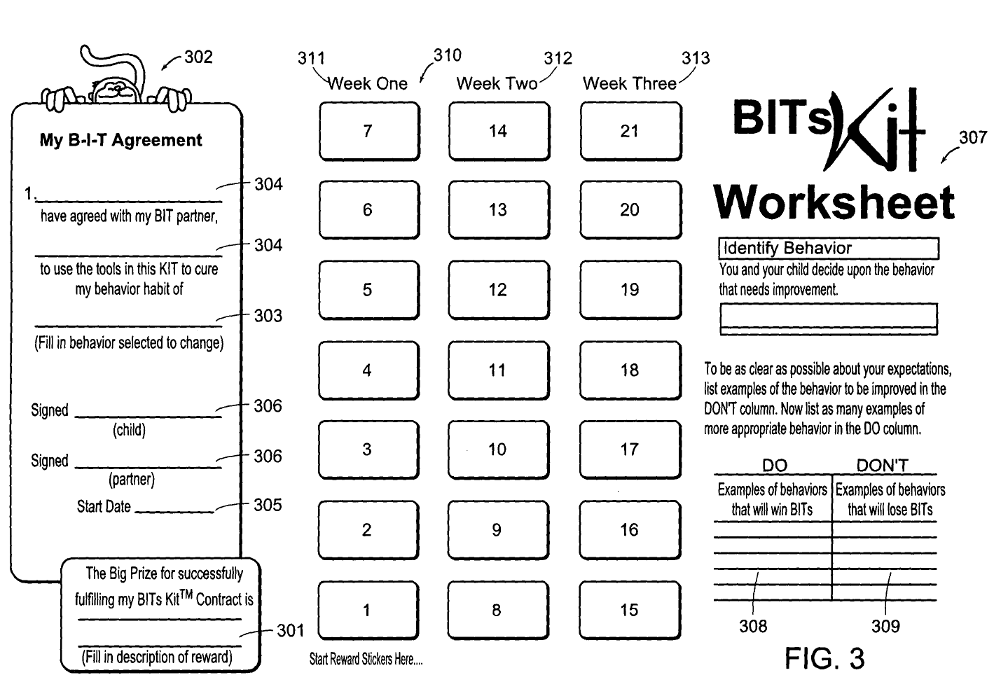

FIG. 3 shows an exemplary contract 302, worksheet 307, and chart 310 that may be used in conjunction with a charm holder to encourage changes in behavior, in accordance with various embodiments of the invention. The contract 302 provides a means for entering into, and reinforcing, an agreement between a child and a parent pertaining to the targeted behavior. The contract may include sections to be filled in by the parent and/or child, identifying, for example, the targeted behavior 303, the parties involved 304, and/or the start date 305. Typically, the contract 302 is agreed to by both the child and the parent, and also includes a section 306 that can be signed by one or both parties.

The contract 302 serves, in part, to identify the agreed upon targeted behavior. To achieve the targeted behavior, a section/worksheet 307 may be filled out by one or both of the parties that clearly identifies what specific acts performed by the child will result in the addition or subtraction of charms from the charm holder. For example, a targeted behavior may be to keep the house clean. Acts that result in a charm being added to the charm holder may include making the bed, vacuuming, and cleaning one's plate after dinner. Acts resulting in a charm being removed from the charm holder may include not picking up one's toys, eating outside of the kitchen area, and not putting dirty clothes in the laundry basket. Breaking up the targeted behavior in this manner helps the child clearly identify good or bad acts associated with the targeted behavior, eliminating any confusion and preventing a child from making any excuses about not knowing what is expected of him/her.

As identified in the contract 302 and/or worksheet 307, each time the child performs a positive act 308, a charm, referred to as a “BIT” in this particular embodiment, is added to a charm holder worn by the child. Each time a child performs a negative act 309, a BIT is removed from the charm holder. Since the charm holder is portable and typically worn by the child throughout the day, the child's attention is often focused on the BIT(s). As a result, the child is continuously reminded of, and motivated to achieve, the targeted behavior.

At the end of the day, the number of bits on the charm holder is examined. If the child has earned a predetermined number of BITs by the end of the day, a prize can be given to the child, and a reward sticker placed on a chart 310 under the appropriate week 311-313. The prize further motivates the child to acquire more bits and achieve the desired behavior. If the child has not earned the predetermined number of BITs for a given day, a sticker indicating the child was not successful is placed on the chart instead. This sticker may be labeled, for example, with kind words of encouragement. Upon earning a predetermined number of reward stickers within the allocated number of days on the chart 310, the child will “graduate” from the program, having successfully achieved the targeted behavior. A grand prize 301 may then be awarded to the child.

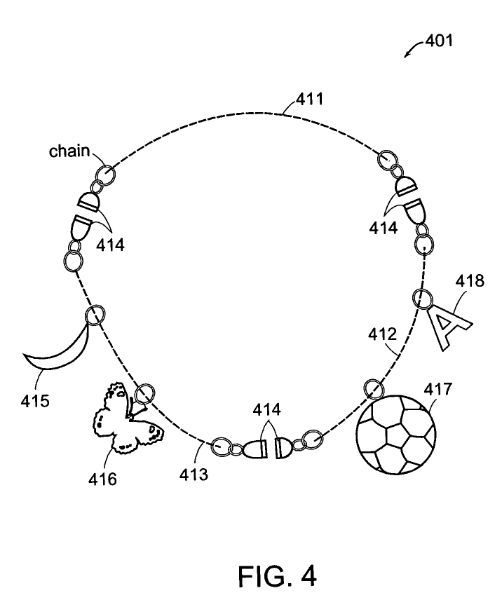

Safety is a primary concern when the child is wearing the charm holder. In particular, it is important that the charm holder provided is not a strangulation hazard for the child. To that end, in accordance with one embodiment of the invention, FIG. 4 shows a charm holder 401 that substantially decreases the risk of strangulation. The charm holder 401 includes a plurality of chains 411-413. Each chain 411-413 has two magnetic clasps 414 at each end of the chain. The chains 411-413 are combined, via the magnetic clasps 414, to form the charm holder 401, as shown in FIG. 4 (with the magnetic clasps 414 shown slightly apart for illustrative purposes). Charms 415-418 are easily attached to or removed from the charm holder using, for example: split rings; jump rings; various types of clasps, such as a lobster claw or C clasp; and/or holes in the charm, as described above.

The length of each chain 411-413 is selected to be sufficiently sized to not pose a strangulation hazard. In various embodiments, the length of each chain 411-413 is no greater than seven inches, which is the length determined to be safe for children by various safety standards, such as the American Academy of Pediatrics (see Widome, M. D., Injury Prevention and Control for Childen, American Academy of Pediatrics, 3^{rd} edition, page 311 (1997), which is incorporated herein by reference in its entirety). For example, each chain may have a length of substantially six inches, and be combined to form a necklace.

Additionally, the magnetic clasps 414 are selected such that the chains 411-413 will separate when a force sufficient to strangulate a child is applied to the charm holder 301 (see, for example, Standard Consumer Safety Specification on Toy Safety, ASTM International, section 4.13.1, 2002, which is incorporated herein by reference in its entirety). In one exemplary embodiment, the magnets have a diameter of 11/32 inches and have a separation force rated at, without limitation, less than 8 pounds/square inch.

Each chain may be made of metal, such as a base metal or a white metal. So that the magnetic clasps do not annoyingly interplay with the chain, non-magnetic metals, may be used. Non-magnetic metals include, without limitation, aluminum, brass, bronze, zinc alloys, aluminum alloys, magnesium alloys, lead, or tin. In alternative embodiments, materials other than metal may be used to form the chain, such as string or plastic.

Instead of magnetic clasps 414, the charm holder 401 may use other types of clasps that enable chains 411-413 to separate when a predetermined force is applied to the charm holder 401. For example, Velcro or another coupling apparatus may be used, or rings/clasps that break under the desired pressure may be used.

Among other things, the charm holder 401 formed in this manner may be a necklace. For example, the necklace may have three six inch chains, such that the total length of the necklace is eighteen inches.

In accordance with one embodiment of the invention, the above-described charm holder 401 may be packaged as a kit. The kit includes at least one charm holder 401, a plurality of charms 415-418, and instructions describing use of the supplied materials to encourage changes in a person's behavior. The charms 415-418 in each kit may be associated with a particular theme(s). Furthermore, the charm holder 401 may include a plurality of chains 411-413 that may be combined, via magnetic or Velcro clasps 414, to form the charm holder 401, which is particularly safe with regard to strangulation. For example, as described above, each chain may be no greater than seven inches in length.

The kit also may include a contract 301 for entering into an agreement pertaining to the targeted behavior, which may be in the form of a chart that also summarizes progress of the child with regard to a targeted behavior, as described above. Stickers for marking spaces on the chart 301, and/or various rewards may also be provided. The rewards may include at least one prize, and/or coins for purchasing one of the prizes.

Although various exemplary embodiment of the invention have been disclosed, it should be apparent to those skilled in the art that various changes and modifications can be made which will achieve some of the advantages of the invention without departing from the true scope of the invention. These and other obvious modifications are intended to be covered by the claims that follow.

1. A method of encouraging a person to modify a behavior, the method comprising:
providing a plurality of chains;
combining the plurality of chains, via magnetic clasps, to form a charm holder capable of being worn by the person; and
adjusting the number of charms attached to the charm holder as a function of the behavior of the person.

2. The method according to claim 1, wherein adjusting includes adding a charm to the charm holder.

3. The method according to claim 2, wherein adding a charm is based on a positive behavior.

4. The method according to claim 1, wherein adjusting includes removing a charm from the charm holder.

5. The method according to claim 4, wherein removing a charm is based on a negative behavior.

6. The method according to claim 1, wherein providing a charm holder includes providing a charm holder chosen from the group consisting of a necklace, a bracelet, and a belt.

7. The method according to claim 1, further comprising attaching the charm holder to the person.

8. The method according to claim 1, wherein providing the charm holder includes attaching a predetermined number of charms to the charm holder.

9. The method according to claim 1, wherein the behavior is unrelated to the act of wearing the charm holder.

10. The method according to claim 1, further comprising:
attaching a predetermined number of charms to the charm holder at the start of a specified duration of time; and
determining whether proper behavior during the specified duration of time has been achieved based at least on the number of charms attached to the charm holder after the specified duration of time has elapsed.

11. The method according to claim 10, further comprising:
providing a plurality of spaces on a chart, each space for marking that proper behavior has been achieved for the specified duration of time; and
marking one of the spaces on the chart when proper behavior for the specified duration of time has been achieved.

12. The method according to claim 11, further comprising repeating attaching, determining, and marking, until a predetermined number of spaces on the chart have been marked.

13. The method according to claim 11, wherein marking one of the spaces on the chart includes attaching a sticker to one of the spaces on the chart.

14. The method according to claim 10, further comprising providing a reward to the person when proper behavior for the specified duration of time has been achieved.

15. The method according to claim 14, wherein providing a reward includes providing a coin that can be used to purchase a prize.

16. (Cancelled)

17. The method according to claim 16, wherein each chain is no greater than seven inches long.

18. The method according to claim 16, wherein each chain is no greater than six inches long.

19. A kit for encouraging a person to modify a behavior, the kit including:
a plurality of chains that can be combined via magnetic clasps to form a charm holder;
a plurality of charms; and
instructions that include directions for adjusting the number of charms attached to the charm holder based at least on the behavior of the person.

20. The kit according to claim 19, wherein the instructions further include directions for:
attaching a predetermined number of charms to the charm holder at the start of a specified duration of time; and
determining whether proper behavior during the specified duration of time has been achieved based at least on the number of charms attached to the charm holder after the predetermined duration of time has elapsed.

21. The kit according to claim 20, further comprising a chart, the chart including a plurality of spaces, each space for marking that proper behavior has been achieved for the specified duration of time, and wherein the instructions further include directions for marking one of the spaces on the chart when proper behavior for the specified duration of time has been achieved.

22. The kit according to claim 21 wherein the instructions further include directions for repeating attaching, determining, and marking, until a predetermined number of spaces on the chart have been marked.

23. The kit according to claim 21, further comprising stickers for marking the spaces on the chart.

24. The kit according to claim 20, further comprising a plurality of rewards, and wherein the instructions include directions for providing at least one of the rewards to the person when proper behavior for the specified duration of time has been achieved.

25. The kit according to claim 24, wherein the plurality of rewards includes at least one coin and at least one prize, the coin for purchasing one of the prizes.

26. The kit according to claim 19, wherein the charm holder is chosen from the group consisting of a necklace, a bracelet, and a belt.

27. (Cancelled)

28. The kit according to claim 19, wherein each chain has a length no greater than seven inches.

29. The kit according to claim 19, wherein each chain has a length no greater than six inches.

30. The kit according to claim 19, wherein the charm holder is a necklace having three chains that are combined via magnetic clasps, and wherein each chain has a length of substantially six inches.

31. A charm holder comprising a plurality of chains, each chain having a first magnetic clasp at a first end and a second magnetic clasp at a second end, wherein the chains are combined, via the magnetic clasps, to form the charm holder.

32. The charm holder according to claim 31, wherein each chain has a length of no greater than seven inches.

33. The charm holder according to claim 31, wherein each chain has a length of no greater than six inches.

34. The charm holder according to claim 31, wherein the charm holder is a necklace having three chains, each chain substantially six inches long.

35. The charm holder according to claim 31, further including one or more charms attached to the charm holder.

36. The charm holder according to claim 31, wherein the charm holder is chosen from the group consisting of a necklace, a bracelet, a carabiner, a pin, a belt and a key ring.

37. The charm holder according to claim 31, wherein each chain is made of non-magnetic metal.

38. The charm holder according to claim 31, wherein each chain is made of one of a string and a plastic.

39. The charm holder according to claim 31, wherein the magnetic clasps separate at forces greater than 7 pounds/square inch.

40. The charm holder according to claim 31, wherein the magnetic clasps separate at forces greater than 5 pounds/square inch.

41. A method of making a charm holder, the method comprising:
providing a plurality of chains, each chain including a first magnetic clasp at a first end and a second magnetic clasp at a second end; and
combining the plurality of chains, via the magnetic clasps, to form the charm holder.

42. The method according to claim 41, wherein each of the plurality of chains is no greater than seven inches.

43. The method according to claim 41, further including attaching one or more charms to the charm holder.

44. The method according to claim 41, wherein the charm holder is chosen from the group consisting of a necklace, a bracelet, a carabiner, a pin, a belt and a key ring.

45. A charm holder comprising:
a plurality of chains, each chain having a length no greater than seven inches; and
means for attaching the plurality of chains together to form the charm holder, the means for attaching separating upon applying a separation force greater than 7 lbs/square inch.

46. The charm holder according to claim 45, where the means for attaching includes one of a magnetic clasp and a Velcro clasp.

47. The charm holder according to claim 45, wherein the charm holder is a necklace having three chains, each chain substantially six inches long.

48. The charm holder according to claim 45, further including one or more charms attached to the charm holder.

49. The charm holder according to claim 45, wherein the charm holder is chosen from the group consisting of a necklace, a bracelet, a carabiner, and a key ring.

50. The charm holder according to claim 45, wherein each chain is made of one of a metal, a string and a plastic.
